(19) United States
(12) Patent Application Publication
(10) Pub. No.: US 2023/0247486 A1
(43) Pub. Date: Aug. 3, 2023

(54) DYNAMIC RESOURCE RECONFIGURATION BASED ON WORKLOAD SEMANTICS AND BEHAVIOR

(71) Applicant: Intel Corporation, Santa Clara, CA (US)

(72) Inventors: Akhilesh Thyagaturu, Tempe, AZ (US); Saidulu Aldas, San Ramon, CA (US); Mohit Kumar Garg, Hisar , Haryana (IN); Vinodh Gopal, Westborough, MA (US); Serey Kong, Beaverton, OR (US)

(73) Assignee: Intel Corporation, Santa Clara, CA (US)

(21) Appl. No.: 18/130,695

(22) Filed: Apr. 4, 2023

(51) Int. Cl. H04W 28/10; H04W 76/36; H04W 28/06

(52) U.S. Cl. CPC H04W 28/10; H04W 28/06; H04W 76/36

(57) ABSTRACT

Dynamic resource reconfiguration based on workload semantics and behavior. A controller may receive, from a core network, a request for an end-to-end managed connection, the end-to-end managed connection for an application executing on a server and an application executing on a client device, where the client device is coupled to the controller via a radio access network (RAN). The controller may determine a policy for the end-to-end managed connection. The controller may apply one or more parameters of the policy to the end-to-end managed connection.

Computing platforms may host different applications, or workloads. Often, many heterogenous workloads are hosted on these platforms. Conventionally, static configurations may be applied to different applications and/or workloads. Doing so may waste system resources as processing demand varies.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates a logic flow 600 in accordance with one embodiment.

FIG. 7 illustrates an aspect of the subject matter in accordance with one embodiment.

### DETAILED DESCRIPTION

Embodiments disclosed herein enable global, end-to-end network flow optimization in a compute path that includes software and hardware components over various computing infrastructures. The software components may include network functions that are implemented in software, which may be referred to as network function virtualization (NFV). A radio access network (RAN), such as a 5G network, may provide user computing devices (e.g., smartphones, vehicles, tablets, laptops, etc.) access to services (e.g., applications, services, etc.) provided by a computing platform, such as a cloud computing platform or edge computing platform. A core network may couple the RAN to the computing platform.

The hardware and/or software components may be optimized using hardware such as processors, network interface cards (NICs), memory, storage, hardware accelerators, and the like. The optimization may enhance application performance for the user computing environment. Embodiments disclosed herein may learn and apply different policies for optimizing the hardware and/or software components based on different heuristics. The policies may be applied to one or more specific network flows, rather than all network flows traversing a network port. For example, a policy may be applied to a network flow for a video streaming application, wherein the policy applies a greater amount of network input/output (I/O) resources relative to other policies. Embodiments are not limited in this context.

Therefore, embodiments disclosed herein provide global coordination for platform configuration that considers end-to-end requirements of a compute path. The platform configuration may be dynamically adjusted using an intelligent controller that coordinates the configuration among all compute nodes or other computing resources in the compute path. Furthermore, the dynamic configuration may be machine learning (ML)-based by learning the needs of a workflow during execution of the workflow to identify the optimal configuration parameters for the workflow (e.g., by learning a policy for the workflow). Furthermore, in some embodiments, the platform optimization may be based on a specific user network flow, where optimization is applied to the specific user network flow based on flow identification, resource estimation, and/or policy enforcement. No modifications to existing protocols are needed to implement the techniques of the disclosure. Therefore, the techniques of the disclosure can be easily adopted and applied.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a = 5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

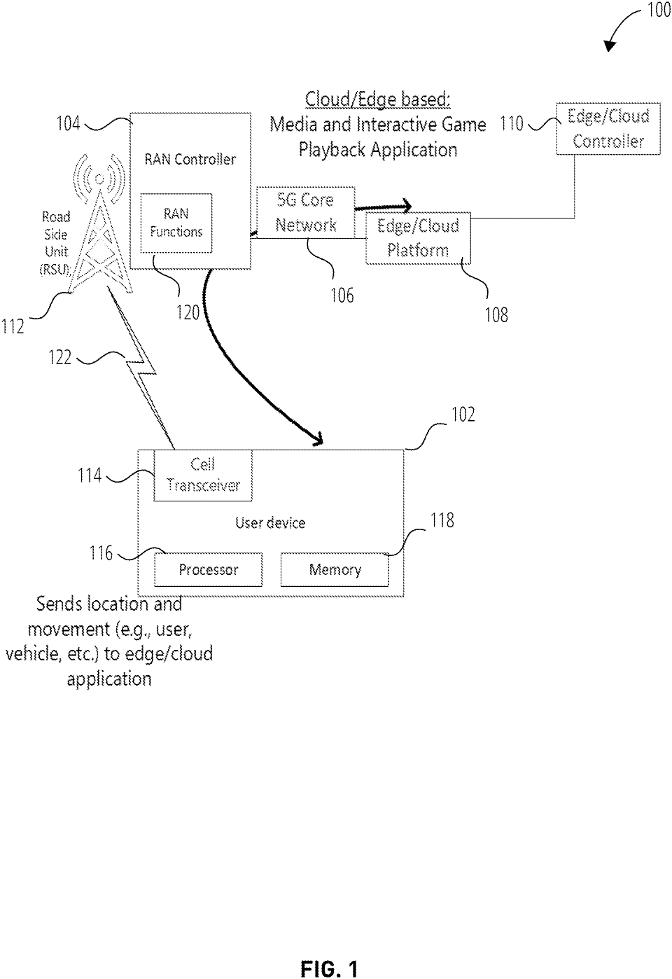

FIG. 1 illustrates an example of a disaggregated (or geographically distributed) system 100. As shown, the system 100 includes a user device 102, a radio access network (RAN) controller 104, a fifth generation (5G) core network 106, an edge/cloud platform 108, and an edge/cloud controller 110. The user device 102 is representative of any type of computing device that can communicate with a road side unit (RSU) 112 associated with the RAN controller 104 via a cell transceiver 114 and a RAN 122. The RAN 122 may be any type of communications network, including cellular communications networks. Therefore, although 5G is used as an example of a cellular communications network, other types of cellular communications networks may be used (e.g., sixth generation (6G) networks). More generally, the cellular communications networks may be according to one or more standards defined by the 3rd Generation Partnership Project (3GPP). In some embodiments, the core network 106 is an Internet backbone. Examples of user devices 102 include, but are not limited to, smartphones, portable gaming devices, tablets, laptops, vehicles, and the like.

As shown, the user device 102 includes a memory 118 and a processor 116, e.g., to store and/or execute one or more applications. The applications may include any type of application, such as gaming applications, music streaming applications, video streaming applications, and the like. The RAN controller 104, 5G core network 106, edge/cloud platform 108, and edge/cloud controller 110 are representative of one or more computing devices (or nodes), each including a processor and memory (not pictured for clarity). For example, the RAN controller 104, 5G core network 106, edge/cloud platform 108 and/or the edge/cloud controller may be implemented as servers, a network appliance (e.g., a router, a switch, etc.), an Infrastructure Processing Unit (IPU), a data processing unit (DPU), and the like. Examples of IPUs include the Intel® IPU and the AMD® Pensando IPU. Examples of DPUs include the Intel DPU, the Fungible DPU, the Marvell® OCTEON and ARMADA DPUs, the NVIDIA BlueField® DPU, and the AMD® Pensando DPU.

The edge/cloud platform 108 may host server-side instances of applications in communication with the applications executing on the user devices 102. Therefore, a network flow may be established over an end-to-end compute path that includes the user device 102, road side unit 112, RAN controller 104, 5G core network 106, edge/cloud platform 108, and/or the edge/cloud controller 110. The path may include one or more RAN functions 120 provided by the RAN controller 104, which may include NFVs. The RAN functions 120 may be any network function, and be implemented as a discrete network element on a dedicated hardware, as a software instance running on dedicated hardware, and/or as a virtualized function instantiated on an appropriate platform, e.g., dedicated hardware or a cloud infrastructure. Therefore, the RAN functions 120 may include 5G network functions, 6G network functions, or any type of network functions. One or more packets of a network flow may be identified using packet inspection, n-tuples, hashing of packet information, and/or packet metadata.

A network flow may be identified based on an Internet protocol (IP) address of the user device 102, an IP address associated with the application (e.g., an address of a physical and/or virtual NIC of a physical and/or virtual compute node hosting the application in the edge/cloud platform 108), a port associated with the user device 102, a port associated with the application (e.g., a physical and/or virtual port of a NIC), and a protocol (e.g., IP, user datagram protocol (UDP), etc.).

Often different applications require different configurations for enhanced performance, especially when a large number of devices are accessing these applications. Embodiments disclosed herein may optimize the system 100 to improve the performance of applications and/or workloads executing in the system 100 by applying policies at the network flow level. For example, a first policy may be applied to a first network flow to optimize a gaming application associated with the first network flow. As another example, a second policy may be applied to a second network flow to optimize a video streaming application associated with the second network flow, where the first policy is different than the second policy.

For example, the RAN controller 104 may identify a flow, parse the flow, and apply one or more policies to the flow. The RAN controller 104 may apply the one or more policies to the flow, but not apply the one or more policies to the entire NIC port that carries all traffic from the RAN controller 104 to the 5G core network 106. The application of policies may be based on one or more RAN functions 120, e.g., user plane function (UPF) optimization functions, physical layer (PHY) functions, medium access control (MAC) layer functions, radio link control (RLC) functions, etc.

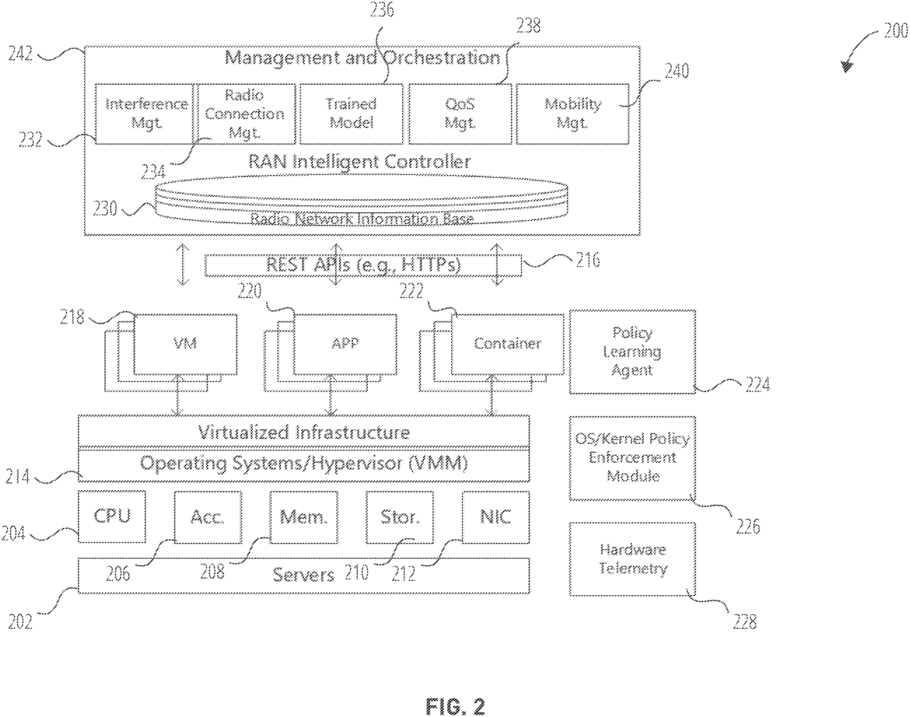

FIG. 2 illustrates a system 200 depicting the components of the RAN controller 104 in greater detail. Although FIG. 2 is discussed with reference to the RAN controller 104, the compute nodes (and other hardware and/or software elements) of the 5G core network 106, the edge/cloud platform 108, and/or the edge/cloud controller 110 may include the components depicted in FIG. 2. As shown, one or more servers 202 may provide a processor 204, hardware accelerator 206, memory 208, storage 210, and one or more network interfaces 212. The server 202 may be representative of the components of the RAN controller 104, nodes in the 5G core network 106, nodes in the edge/cloud platform 108, and/or nodes in the edge/cloud controller 110. The hardware telemetry monitor 228 of the servers 202 may monitor attributes of the processor 204, accelerator 206, memory 208, storage 210, and network interfaces 212. The hardware telemetry monitor 228 may be an in-band network telemetry (INT) monitor. An operating system (OS) and/or hypervisor 214 may execute on the servers 202 and provide a virtualized infrastructure to one or more virtual machines (VMs) 218, applications 220, containers 222, and a policy learning agent 224. The OS/hypervisor 214 may provide a policy enforcement module 226.

The RAN controller 104 may include RAN functions 120 such as interference management 232, radio connection management 234, trained model 236, quality of service (QoS) management 238, and mobility management 240 provided via a management and orchestration layer 242. The management and orchestration layer 242 of the RAN controller 104 may further include a RAN database 230. The management and orchestration layer 242 may communicate with the virtual machines 218, applications 220, containers 222, and policy learning agent 224 via one or more REST APIs 216.

The policy learning agent 224 may generally learn the characteristics of the systems 100, 200, including any NIC policies such as the Dynamic Device Profile (DDP) characteristics, and apply these policies to one or more network flows. For example, the policy learning agent 224 may define a policy for a first application 220 associated with a first user device 102 and associate the first policy to a first network flow for the first application and the first user device, e.g., by storing an indication in the RAN database 230 that the first policy is to be applied to the first network flow. When data associated with the first flow is identified, the policy may be applied to the first flow such that the policy parameters are met by the underlying hardware processing the first flow.

Subsequently, the policy learning agent 224 may determine to dynamically adjust the policy for the first network flow, e.g., to a second policy. The policy enforcement module 226 enforces the application of different policies to different network flows, e.g., by identifying a flow and the policies associated with the flow (e.g., in the RAN database 230). The RAN database 230 may therefore store indications of policies and associations between one or more flows and one or more policies. The policy enforcement module 226 may receive telemetry data from the hardware telemetry monitor 228 indicating the use of different resources and/or different states of the hardware. The policy enforcement module 226 may further enforce the policy such that the hardware operates at the levels defined by the policy. Therefore, for example, if the telemetry data indicates the CPU is operating at a frequency lower than is specified by a policy for a flow, the policy enforcement module 226 may cause the CPU to operate at the frequency specified by the policy for the flow. In some embodiments, a flag in an application may be set to enable the policy application and enforcement disclosed herein. Therefore, when the operating system and/or hypervisor detects the flag, the policy application and/or enforcement may be applied.

In some embodiments, the policy enforcement module 226 may interface with other system platforms to configure hardware and/or software. Example of platforms to apply policies to configure hardware and/or software include the Intel Resource Director Technology (RDT), the Intel Data Streaming Accelerator (DSA), and the Intel Dynamic Load Balancer (DLB). Other examples of platforms to apply policies to configure hardware and/or software include the AMD® Platform Quality of Service (PQoS) and ARM@ QoS Regulators.

Conventional implementations may not provide context of an end-to-end application, and therefore the connections, platform reservations, and device profiles may be maintained throughout the lifetime of the deployment of an application. This is because a flow may originate at any time, and the network may be ready to serve such flows. In some embodiments, however, end-to-end coordination for network flows may allow the user application to originate the flow based on a request for policy enforcement and provisioning of resources before a connection is established.

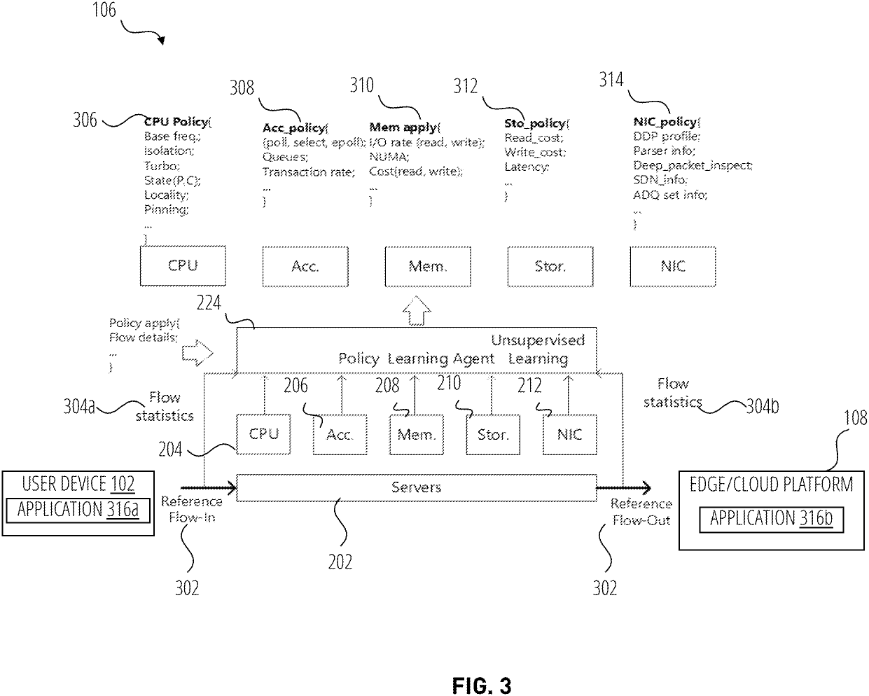

FIG. 3 is a schematic illustrating a reference flow 302 that is associated with an applications 316a executing on a user device 102 and a corresponding instance of the application 316b executing in the edge/cloud platform 108. As shown, the reference flow 302 may pass through one or more servers 202. In the example depicted in FIG. 3, the server 202 is in the 5G core network 106. In some embodiments, the server 202 in FIG. 3 may be different than the server 202 of FIG. 2. Generally, the reference flow 302 may enter the server 202 via a first network interface 212 and exit the server 202 via another network interface 212. One endpoint of the flow 302 may be the application 316a on user device 102, while another endpoint of the flow 302 may be the application 316b on the edge/cloud platform 108. The RAN 122 is not pictured in FIG. 3 for the sake of clarity. Therefore, the end-to-end managed connection for the flow 302 may include all hardware between the user device 102 and the compute node hosting the application 316b in the edge/cloud platform 108, e.g., the RAN controller 104, the 5G core network 106, the edge/cloud platform 108, and/or the edge/cloud controller 110. The application 316a or 316b may include a flag to indicate to establish and apply a policy to the flow 302.

As shown, flow statistics 304a and flow statistics 304b may be provided to the policy learning agent 224, e.g., by the hardware telemetry monitor 228. The flow statistics 304a, flow statistics 304b generally describe different attributes of the flow, such as bandwidth, number of packets associated the flow, protocol, etc. The flow statistics 304a, flow statistics 304b may further include data describing the processor 204 (e.g., operating frequency, isolation, program counter state, locality, pinning, etc.), accelerator 206 (queue information, transaction rates, etc.), memory 208 (I/O rate, whether non-uniform memory access (NUMA) is enabled, cost, etc.), storage 210 (e.g., I/O rate, cost, latency, etc.), and network interfaces 212 (e.g., DDP profiles, parser information, deep packet inspection information, software-defined networking information, application device queues (ADQs), bandwidth, throughput, etc.). The flow statistics 304a, flow statistics 304b may be associated with a specific flow.

Therefore, the policy learning agent 224 may apply unsupervised learning (e.g., via an unsupervised machine learning algorithm) to learn a policy for the flow based on the flow statistics 304a, flow statistics 304b. For example, as shown, the policy learning agent 224 may learn a CPU policy 306 for the processor 204, an accelerator policy 308 for the accelerator 206, a memory policy 310 for the memory 208, a storage policy 312 for the storage 210, and/or a NIC policy 314 for the network interfaces 212. The CPU policy 306 may define one or more parameters for base operating frequency, isolation, turbo (e.g., to enable/disable a turbo feature), processor state, locality, and/or pinning. The accelerator policy 308 may define one or more parameters for I/O multiplexing (e.g., whether to apply poll, select, or epoll), queues, and/or transaction rate. The memory policy 310 may define one or more parameters for I/O rate for read and/or write operations, whether NUMA is enabled, and/or the cost of read and/or write operations. The storage policy 312 may define one or more parameters for read cost, write cost, and/or latency. The NIC policy 314 may define one or more parameters for the DDP profile, parser information, deep packet inspection, SDN information, ADQ set info, and the like.

Generally, once one or more policies are defined, the policy can be enabled with resource reservation end-to-end from the user device 102 to the edge/cloud platform 108 in an on-demand fashion. Doing so eliminates the need to keep all resources and/or policies applied to the resources alive all the time on intermediate processing nodes.

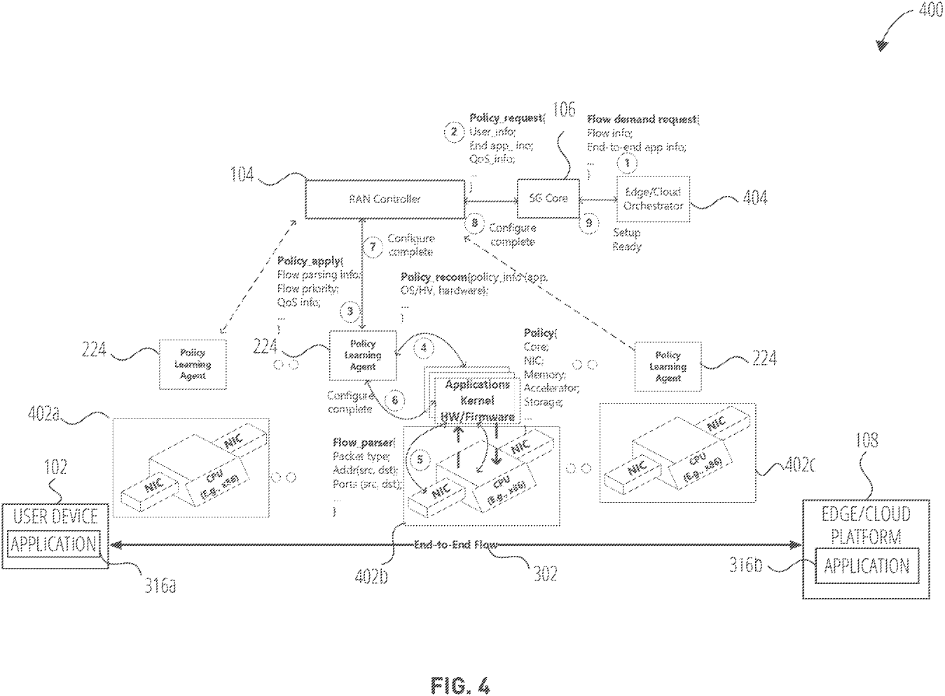

FIG. 4 illustrates an example flow diagram 400 for dynamic resource configuration based on workload semantics and behavior, according to one embodiment. Generally, static enforcement of policies does not provide an optimal resource utilization. However, embodiments disclosed herein apply policies to the corresponding domain each time a flow initialization occurs. In some embodiments, the policies are applied based on a flag set the code for an application, VM, and/or container. For example, a DDP profile (e.g., a NIC policy 314) may be applied to the network interface 212, a CPU policy 306 may be applied to one or more processors 204, memory policies 310 may be applied to memory 208, storage policies 312 may be applied to the storage 210, and accelerator policies 308 may be applied to the accelerator 206. Furthermore, a given instance of an application, VM, and/or container may have different performance attributes than another instance of the application, VM, and/or container. Therefore, different flows for these applications, VMs, and/or containers may be associated with different policies.

The RAN controller 104 orchestrates dynamic reconfiguration by adding and/or deleting policies. Furthermore, the RAN controller 104 may apply different policies to one or more flows. Further still, the RAN controller 104 may share policies (including any policies applied to specific flows) throughout the system 100, e.g., with the 5G core network 106, the edge/cloud platform 108, and/or the edge/cloud controller 110. Each node, hardware entity, and/or software entity in the flow 302 may include an instance of the policy learning agent 224 trained to learn different specific policies that may be stored as the trained model 236. The RAN controller 104 may request policy enforcement at each node of the end-to-end path of the flow 302, where one or more nodes may implement one or more RAN functions 120. As stated, the end-to-end path of the flow may include the RAN controller 104, the 5G core network 106, the edge/cloud platform 108, and/or the edge/cloud controller 110 (which may include the edge/cloud orchestrator 404 of FIG. 4). The servers 402a-402c may be representative of one or more nodes in the end-to-end path of the flow 302. Because each node includes a corresponding instance of the policy learning agent 224, each node may have a respective plurality of policies, including one or more CPU policies 306, one or more accelerator policies 308, one or more memory policies 310, one or more storage policies 312, and one or more NIC policies 314. A given policy may be applied to one or more flows, such as flow 302. Therefore, each node that hosts a RAN function 120 applies policies specific to that node for a given flow. The policy may be terminated when the end-to-end managed connection no longer requires the policy, such that resources are released for more efficient resource utilization (e.g., by allocating released resources to a different flow, or powering down unused resources). In some embodiments, an application such as application 316a and application 316b may be automatically recompiled to leverage different hardware available in the end-to-end path. For example, generative artificial intelligence (AI) may be used to recompile the application 316a and application 316b to use an accelerator 206. If, however, the accelerator 206 is not available in a given platform, the generative AI may recompile the application 316a and application 316b to not use the accelerator 206.

For example, as shown in FIG. 4, at circle 1, the edge/cloud orchestrator 404 may transmit a request to the 5G core network 106, where the request is to include flow information and end-to-end application information, e.g., for the application 316a, application 316b. The request may be initiated by an instance of an application, e.g., application 316b. At circle 2, the 5G core network 106 transmits a policy request to the RAN controller 104. The request may be based on user information, application information, and QoS information. The QoS information may be a policy, e.g., one or more required parameters for the application (e.g., bandwidth, latency, CPU frequency, etc.).

At circle 3, the RAN controller 104 causes the policy learning agent 224 of each of a plurality of servers 402a-402c to determine and apply a policy for the flow 302based on flow parsing information, flow priority, and the QoS information. As stated, the servers 402a-402c are representative of one or more nodes in the 5G core network 106, the edge/cloud platform 108, and/or the edge/cloud controller 110. The servers 402a-402c may be the same as the server 202. At circle 4, the policy learning agent 224 may interact with the OS, applications, kernel, hardware, and/or firmware of the server 402a-402c upon which it executes to determine and apply a policy (e.g., a CPU policy 306, accelerator policy 308, memory policy 310, storage policy 312, and/or NIC policy 314). At circle 5, the servers 402a-402c parse flows and provide flow statistics 304a, 304b to the policy learning agent 224, which may refine the policies based on the flow statistics 304a, 304b, and any other operational parameters of the processors 204, accelerator 206, memory 208, storage 210, and/or network interfaces 212. There may be a continuous loop between the operations at circles 4 and 5 to continuously refine the policies for a flow 302 based on the needs of the hardware and software.

At circles 6, 7, and 8, indications of the completed configuration may be transmitted to the policy learning agent 224, RAN controller 104, and 5G core network 106, respectively. At circle 9, the 5G core network 106 transmits, to the edge/cloud orchestrator 404, an indication that setup for the flow demand request has been completed.

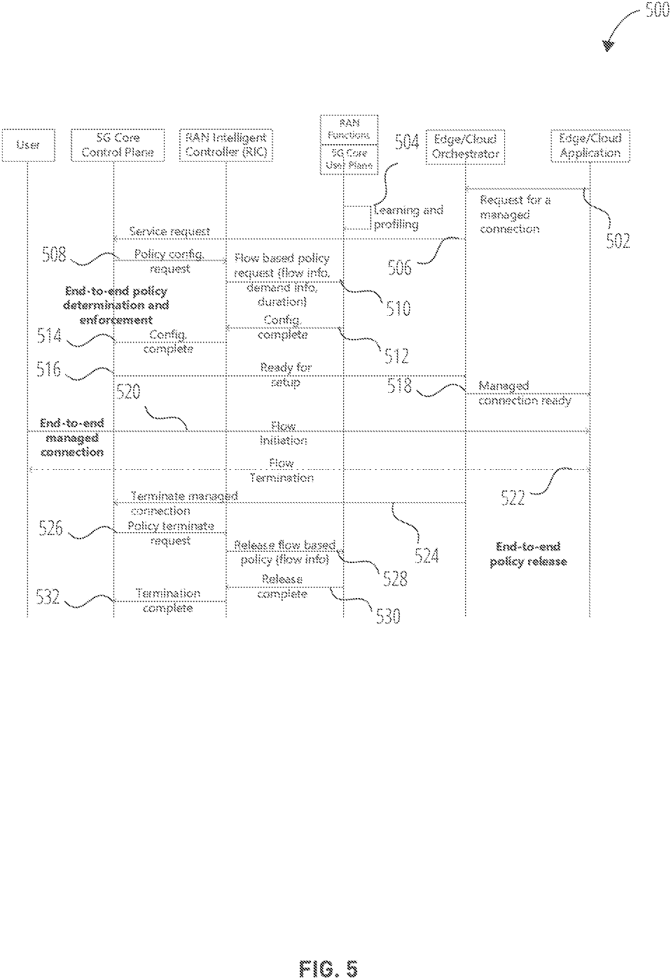

FIG. 5 illustrates a flow diagram 500. The flow diagram 500 may be representative of some or all of the steps to provide dynamic resource configuration based on workload semantics and behavior. Embodiments are not limited in this context.

As shown, at line 502, an edge/cloud application (e.g., the application 316b) executing on a node in the edge/cloud platform 108 may transmit a request for a managed connection to the edge/cloud orchestrator 404 of the edge/cloud controller 110. For example, the application may be a gaming application, a video streaming application, audio streaming application, or any type of application. In some embodiments, the edge/cloud orchestrator 404 may provide the application 316b with credentials required to authenticate a request with the 5G core network 106 control plane. Therefore, the application 316b may include the credentials at line 502. At line 504, continuous learning and profiling is applied by the policy learning agent 224 to learn one or more policies for one or more network flows, such as the flow 302.

At line 506, the edge/cloud orchestrator 404 transmits a service request for the managed connection to a control plane component of the 5G core network 106. At line 508, the control plane of the 5G core network 106 sends a policy configuration request for the managed connection to the RAN controller 104. At line 510, the RAN controller 104 may transmit a request for a flow-based policy to the 5G core network 106 user plane. The request may specify the network flow attributes, one or more parameters for the policy (e.g., I/O rate, bandwidth, CPU frequencies, etc.), and a duration for the policy. The 5G core network 106, RAN controller 104, and/or RAN functions 120 may determine whether the requested policy parameters can be fulfilled (e.g., based on available resources, predicted use of the resources, etc.).

At line 512, the 5G core network 106 user plane configures the requested policy for the flow, e.g., by associating one or more policies with the network flow. At line 512, the 5G core network 106 transmits a response to the RAN controller 104 indicating the configuration is complete. At line 514, the RAN controller 104 transmits a response to the 5G core network 106 control plane indicating the configuration is complete. At line 516, the 5G core network 106 control plane transmits a response to the edge/cloud orchestrator 404 indicating the connection is ready for setup. At line 518, the edge/cloud orchestrator 404 transmits a response to application indicating the managed connection is ready. At line 520, an application (e.g., application 316a) on the user device 102 initiates the flow with the edge/cloud platform 108 application (e.g., application 316b).

At this point, the applications 316a, 316b may exchange data via the managed connection. For example, the user may play an interactive video game. Doing so allows the video game to be allocated the relevant operating parameters associated with the policy at each computing resource associated with the managed connection. For example, the RAN controller 104, 5G core network 106, edge/cloud platform 108, edge/cloud controller 110, and/or edge/cloud orchestrator 404 may operate according to one or more policies associated with the flow.

At line 522, the flow may terminate, e.g., based on an instruction from the application 316b to the application 316a. At line 524, the edge/cloud orchestrator 404 transmits an instruction to the 5G core network 106 control plane to terminate the managed connection. At line 526, the 5G core network 106 control plane transmits a request to terminate the policy for the flow. At line 528, the RAN controller 104 requests the 5G core network 106 user plane and/or the RAN functions 120 to release the policy for the flow. The 5G core network 106 user plane and/or the RAN functions 120 may then release the policy for the flow, thereby freeing up resources associated with the policy. At line 530, the 5G core network 106 user plane transmits a response to the RAN controller 104 indicating the policy for the flow has been released. At line 532, the RAN controller 104 transmits an indication to the 5G core network 106 control plane indicating the termination of the policy for the flow is complete.

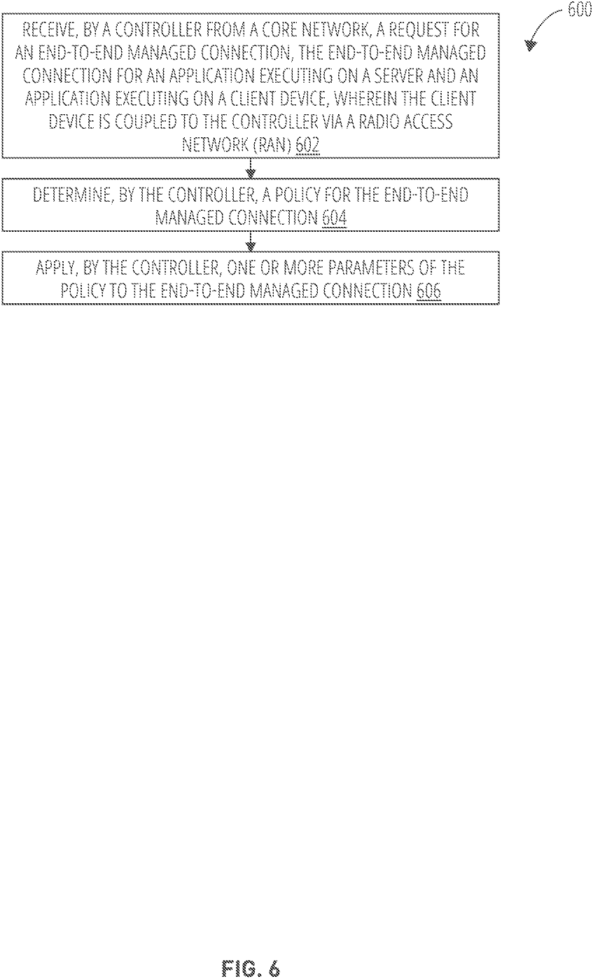

FIG. 6 illustrates a logic flow 600. The logic flow 600 may be representative of some or all of the steps to provide dynamic resource configuration based on workload semantics and behavior. Embodiments are not limited in this context.

In block 602, logic flow 600 receives, by a controller (e.g., the RAN controller 104) from a core network (e.g., the 5G core network 106), a request for an end-to-end managed connection. The end-to-end managed connection may be for an application executing on a server (e.g., the applications 316b) and an application executing on a client device (e.g., the application 316a of user device 102), wherein the client device is coupled to the controller via a radio access network (RAN). In block 604, logic flow 600 determines, by the controller, a policy for the end-to-end managed connection. For example, the policy may specify CPU operating parameters, memory parameters, storage parameters, NIC parameters, and accelerator parameters. In block 606, logic flow 600 applies, by the controller, one or more parameters of the policy to the end-to-end managed connection. For example, the policy enforcement module 226 may apply the CPU parameters to the processor 204, apply the memory parameters to the memory 208, apply the storage parameters to the storage 210, apply the NIC parameters to the network interface 212, and apply the accelerator parameters to the accelerator 206. Embodiments are not limited in this context.

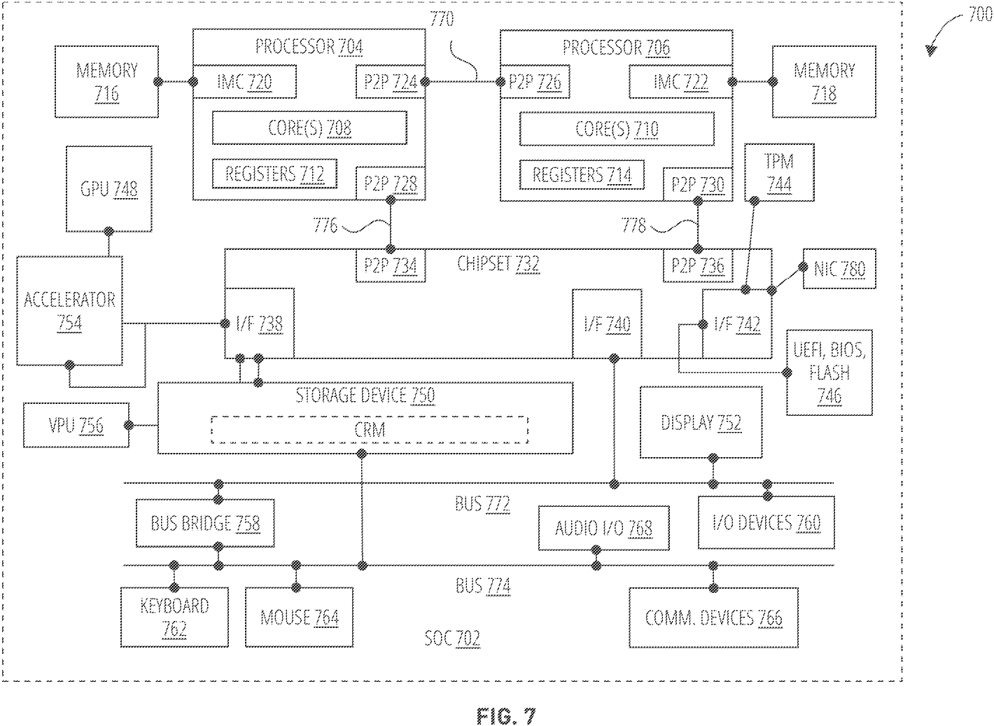

FIG. 7 illustrates an embodiment of a system 700. System 700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 700 may have a single processor with one core or more than one processor. Note that the term “processor” refers to a processor with a single core or a processor package with multiple processor cores. In at least one embodiment, the computing system 700 is representative of the components of the components of the systems 100, 200, server 202, and servers 402a-402c, including the RAN controller 104, 5G core network 106, edge/cloud platform 108, and/or edge/cloud controller 110. More generally, the computing system 700 is configured to implement all logic, systems, logic flows, methods, apparatuses, and functionality described herein with reference to FIGS. 1-6.

As used in this application, the terms “system” and “component” and “module” are intended to refer to a computer-related entity, either hardware, a combination of hardware and software, software, or software in execution, examples of which are provided by the exemplary system 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 7, system 700 comprises a system-on-chip (SoC) 702 for mounting platform components. System-on-chip (SoC) 702 is a point-to-point (P2P) interconnect platform that includes a first processor 704 and a second processor 706 coupled via a point-to-point interconnect 770 such as an Ultra Path Interconnect (UPI). In other embodiments, the system 700 may be of another bus architecture, such as a multi-drop bus. Furthermore, each of processor 704 and processor 706 may be processor packages with multiple processor cores including core(s) 708 and core(s) 710, respectively. While the system 700 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform may refers to a motherboard with certain components mounted such as the processor 704 and chipset 732. Some platforms may include additional components and some platforms may only include sockets to mount the processors and/or the chipset. Furthermore, some platforms may not have sockets (e.g. SoC, or the like). Although depicted as a SoC 702, one or more of the components of the SoC 702 may also be included in a single die package, a multi-chip module (MCM), a multi-die package, a chiplet, a bridge, and/or an interposer. Therefore, embodiments are not limited to a SoC.

The processor 704 and processor 706 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 704 and/or processor 706. Additionally, the processor 704 need not be identical to processor 706.

Processor 704 includes an integrated memory controller (IMC) 720 and point-to-point (P2P) interface 724 and P2P interface 728. Similarly, the processor 706 includes an IMC 722 as well as P2P interface 726 and P2P interface 730. IMC 720 and IMC 722 couple the processor 704 and processor 706, respectively, to respective memories (e.g., memory 716 and memory 718). Memory 716 and memory 718 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 716 and the memory 718 locally attach to the respective processors (e.g., processor 704 and processor 706). In other embodiments, the main memory may couple with the processors via a bus and shared memory hub. Processor 704 includes registers 712 and processor 706 includes registers 714.

System 700 includes chipset 732 coupled to processor 704 and processor 706. Furthermore, chipset 732 can be coupled to storage device 750, for example, via an interface (I/F) 738. The I/F 738 may be, for example, a Peripheral Component Interconnect-enhanced (PCIe) interface, a Compute Express Link ® (CXL) interface, or a Universal Chiplet Interconnect Express (UCIe) interface. Storage device 750 can store instructions executable by circuitry of system 700 (e.g., processor 704, processor 706, GPU 748, accelerator 754, vision processing unit 756, or the like).

Processor 704 couples to the chipset 732 via P2P interface 728 and P2P 734 while processor 706 couples to the chipset 732 via P2P interface 730 and P2P 736. Direct media interface (DMI) 776 and DMI 778 may couple the P2P interface 728 and the P2P 734 and the P2P interface 730 and P2P 736, respectively. DMI 776 and DMI 778 may be a high-speed interconnect that facilitates, e.g., eight Giga Transfers per second (GT/s) such as DMI 3.0. In other embodiments, the processor 704 and processor 706 may interconnect via a bus.

The chipset 732 may comprise a controller hub such as a platform controller hub (PCH). The chipset 732 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 732 may comprise more than one controller hub such as a chipset with a memory controller hub, a graphics controller hub, and an input/output (I/O) controller hub.

In the depicted example, chipset 732 couples with a trusted platform module (TPM) 744 and UEFI, BIOS, FLASH circuitry 746 via I/F 742. The TPM 744 is a dedicated microcontroller designed to secure hardware by integrating cryptographic keys into devices. The UEFI, BIOS, FLASH circuitry 746 may provide pre-boot code.

Furthermore, chipset 732 includes the I/F 738 to couple chipset 732 with a high-performance graphics engine, such as, graphics processing circuitry or a graphics processing unit (GPU) 748. In other embodiments, the system 700 may include a flexible display interface (FDI) (not shown) between the processor 704 and/or the processor 706 and the chipset 732. The FDI interconnects a graphics processor core in one or more of processor 704 and/or processor 706 with the chipset 732.

The system 700 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth® wireless technologies, 3G, 4G, LTE wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Additionally, accelerator 754 and/or vision processing unit 756 can be coupled to chipset 732 via I/F 738. The accelerator 754 is representative of any type of accelerator device (e.g., a data streaming accelerator, cryptographic accelerator, cryptographic co-processor, an offload engine, etc.). One example of an accelerator 754 is the Intel® Data Streaming Accelerator (DSA). Another example of an accelerator 754 is the AMD Instinct® accelerator. The accelerator 754 may be a device including circuitry to accelerate copy operations, data encryption, hash value computation, data comparison operations (including comparison of data in memory 716 and/or memory 718), and/or data compression. For example, the accelerator 754 may be a USB device, PCI device, PCIe device, CXL device, UCIe device, and/or an SPI device. The accelerator 754 can also include circuitry arranged to execute machine learning (ML) related operations (e.g., training, inference, etc.) for ML models. Generally, the accelerator 754 may be specially designed to perform computationally intensive operations, such as hash value computations, comparison operations, cryptographic operations, and/or compression operations, in a manner that is more efficient than when performed by the processor 704 or processor 706. Because the load of the system 700 may include hash value computations, comparison operations, cryptographic operations, and/or compression operations, the accelerator 754 can greatly increase performance of the system 700 for these operations.

The accelerator 754 may include one or more dedicated work queues and one or more shared work queues (each not pictured). Generally, a shared work queue is configured to store descriptors submitted by multiple software entities. The software may be any type of executable code, such as a process, a thread, an application, a virtual machine, a container, a microservice, etc., that share the accelerator 754. For example, the accelerator 754 may be shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 754 via a non-posted write (e.g., a deferred memory write (DMWr)). One example of an instruction that atomically submits a work descriptor to the shared work queue of the accelerator 754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 754. The dedicated work queue may accept job submissions via commands such as the movdir64b instruction.

The accelerator 754 may be representative of the accelerator 206. The processors 704, 706 may be representative of the processor 116 and the processor 204. The memories 716, 718 may be representative of the memory 118 and the memory 208. The storage device 750 may be representative of the storage 210. The network interface 780 may be representative of the network interface 212.

Various I/O devices 760 and display 752 couple to the bus 772, along with a bus bridge 758 which couples the bus 772 to a second bus 774 and an I/F 740 that connects the bus 772 with the chipset 732. In one embodiment, the second bus 774 may be a low pin count (LPC) bus. Various devices may couple to the second bus 774 including, for example, a keyboard 762, a mouse 764 and communication devices 766.

Furthermore, an audio I/O 768 may couple to second bus 774. Many of the I/O devices 760 and communication devices 766 may reside on the system-on-chip (SoC) 702 while the keyboard 762 and the mouse 764 may be add-on peripherals. In other embodiments, some or all the I/O devices 760 and communication devices 766 are add-on peripherals and do not reside on the system-on-chip (SoC) 702.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-7 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

Example 1 includes an apparatus, comprising: an interface to a radio access network (RAN); and a processor to execute one or more instructions to cause the processor to: receive, from a core network, a request for an end-to-end managed connection, the end-to-end managed connection for an application executing on a server and an application executing on a client device; determine a policy for the end-to-end managed connection; and apply one or more parameters of the policy to the end-to-end managed connection.

Example 2 includes the subject matter of example 1, the processor to execute one or more instructions to cause the processor to: determine a network flow associated with the end-to-end managed connection, wherein the one or more parameters of the policy are to be applied to the network flow.

Example 3 includes the subject matter of example 2, the processor to execute one or more instructions to cause the processor to: modify the policy based on a machine learning algorithm applied to a plurality of attributes of the network flow and telemetry data for a plurality of compute nodes hosting the end-to-end managed connection; and apply the modified policy to the network flow.

Example 4 includes the subject matter of example 2, the processor to execute one or more instructions to cause the processor to: receive, from the application executing on the client device and via the RAN, a packet; parse the packet to determine the packet is associated with the network flow; and apply the policy to the packet based on the determination that the packet is associated with the network flow.

Example 5 includes the subject matter of example 1, the processor to execute one or more instructions to cause the processor to: receive a request to terminate the end-to-end managed connection; terminate the end-to-end managed connection; and release one or more computing resources based on the termination of the end-to-end managed connection.

Example 6 includes the subject matter of example 1, the processor to execute one or more instructions to cause the processor to: transmit, to the core network, an indication of the policy.

Example 7 includes the subject matter of example 1, wherein the one or more parameters of the policy are to comprise one or more of: (i) parameters for the processor, (ii) parameters for a memory, (iii) parameters for an accelerator device, and (iv) parameters for a storage device.

Example 8 includes a method, comprising: receiving, by a controller from a core network, a request for an end-to-end managed connection, the end-to-end managed connection for an application executing on a server and an application executing on a client device, wherein the client device is coupled to the controller via a radio access network (RAN); determining, by the controller, a policy for the end-to-end managed connection; and applying, by the controller, one or more parameters of the policy to the end-to-end managed connection.

Example 9 includes the subject matter of example 8, further comprising: determining, by the controller, a network flow associated with the end-to-end managed connection, wherein the one or more parameters of the policy are to be applied to the network flow.

Example 10 includes the subject matter of example 9, further comprising: modifying, by the controller, the policy based on a machine learning algorithm applied to a plurality of attributes of the network flow and telemetry data for a plurality of compute nodes hosting the end-to-end managed connection; and applying, by the controller, the modified policy to the network flow.

Example 11 includes the subject matter of example 9, further comprising: receiving, by the controller from the application executing on the client device and via the RAN, a packet; parsing, by the controller, the packet to determine the packet is associated with the network flow; and applying, by the controller, the policy to the packet based on the determination that the packet is associated with the network flow.

Example 12 includes the subject matter of example 8, further comprising: receiving, by the controller, a request to terminate the end-to-end managed connection; terminating, by the controller, the end-to-end managed connection; and releasing, by the controller, one or more computing resources based on the termination of the end-to-end managed connection.

Example 13 includes the subject matter of example 8, further comprising: transmitting, by the controller to the core network, an indication of the policy.

Example 14 includes the subject matter of example 8, wherein the one or more parameters of the policy are to comprise one or more of: (i) parameters for the processor, (ii) parameters for a memory, (iii) parameters for an accelerator device, and (iv) parameters for a storage device.

Example 15 includes a non-transitory computer-readable storage medium, the computer-readable storage medium including instructions that when executed by a processor of a controller, cause the processor to: receive, from a core network, a request for an end-to-end managed connection, the end-to-end managed connection for an application executing on a server and an application executing on a client device, wherein the client device is coupled to the controller via a radio access network (RAN); determine a policy for the end-to-end managed connection; and apply one or more parameters of the policy to the end-to-end managed connection.

Example 16 includes the subject matter of example 15, wherein the instructions further cause the processor to: determine a network flow associated with the end-to-end managed connection, wherein the one or more parameters of the policy are to be applied to the network flow.

Example 17 includes the subject matter of example 16, wherein the instructions further cause the processor to: modify the policy based on a machine learning algorithm applied to a plurality of attributes of the network flow and telemetry data for a plurality of compute nodes hosting the end-to-end managed connection; and apply the modified policy to the network flow.

Example 18 includes the subject matter of example 16, wherein the instructions further cause the processor to: receive from the application executing on the client device and via the RAN, a packet; parse the packet to determine the packet is associated with the network flow; and apply, by the controller, the policy to the packet based on the determination that the packet is associated with the network flow.

Example 19 includes the subject matter of example 15, wherein the instructions further cause the processor to: receive a request to terminate the end-to-end managed connection; terminate the end-to-end managed connection; and release one or more computing resources based on the termination of the end-to-end managed connection.

Example 20 includes the subject matter of example 15, wherein the instructions further cause the processor to: transmit, to the core network, an indication of the policy.

Example 21 includes the subject matter of example 15, wherein the one or more parameters of the policy are to comprise one or more of: (i) parameters for the processor, (ii) parameters for a memory, (iii) parameters for an accelerator device, and (iv) parameters for a storage device.

Example 22 includes an apparatus, comprising: means for receiving, from a core network, a request for an end-to-end managed connection, the end-to-end managed connection for an application executing on a server and an application executing on a client device, wherein the client device is coupled to the controller via a radio access network (RAN); means for determining a policy for the end-to-end managed connection; and means for applying one or more parameters of the policy to the end-to-end managed connection.

Example 23 includes the subject matter of example 22, further comprising: means for determining a network flow associated with the end-to-end managed connection, wherein the one or more parameters of the policy are to be applied to the network flow.

Example 24 includes the subject matter of example 23, further comprising: means for modifying the policy based on a machine learning algorithm applied to a plurality of attributes of the network flow and telemetry data for a plurality of compute nodes hosting the end-to-end managed connection; and means for applying the modified policy to the network flow.

Example 25 includes the subject matter of example 23, further comprising: means for receiving, from the application executing on the client device and via the RAN, a packet; means for parsing the packet to determine the packet is associated with the network flow; and means for applying the policy to the packet based on the determination that the packet is associated with the network flow.

Example 26 includes the subject matter of example 22, further comprising: means for receiving a request to terminate the end-to-end managed connection; means for terminating the end-to-end managed connection; and means for releasing one or more computing resources based on the termination of the end-to-end managed connection.

Example 27 includes the subject matter of example 22, further comprising: means for transmitting, by the controller to the core network, an indication of the policy.

Example 28 includes the subject matter of example 22, wherein the one or more parameters of the policy are to comprise one or more of: (i) parameters for the processor, (ii) parameters for a memory, (iii) parameters for an accelerator device, and (iv) parameters for a storage device.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. An apparatus, comprising:
an interface to a radio access network (RAN); and
a processor to execute one or more instructions to cause the processor to:
receive, from a core network, a request for an end-to-end managed connection, the end-to-end managed connection for an application executing on a server and an application executing on a client device;
determine a policy for the end-to-end managed connection; and
apply one or more parameters of the policy to the end-to-end managed connection.

2. The apparatus of claim 1, the processor to execute one or more instructions to cause the processor to:
determine a network flow associated with the end-to-end managed connection, wherein the one or more parameters of the policy are to be applied to the network flow.

3. The apparatus of claim 2, the processor to execute one or more instructions to cause the processor to:
modify the policy based on a machine learning algorithm applied to a plurality of attributes of the network flow and telemetry data for a plurality of compute nodes hosting the end-to-end managed connection; and
apply the modified policy to the network flow.

4. The apparatus of claim 2, the processor to execute one or more instructions to cause the processor to:
receive, from the application executing on the client device and via the RAN, a packet;
parse the packet to determine the packet is associated with the network flow; and
apply the policy to the packet based on the determination that the packet is associated with the network flow.

5. The apparatus of claim 1, the processor to execute one or more instructions to cause the processor to:
receive a request to terminate the end-to-end managed connection;
terminate the end-to-end managed connection; and
release one or more computing resources based on the termination of the end-to-end managed connection.

6. The apparatus of claim 1, the processor to execute one or more instructions to cause the processor to:
transmit, to the core network, an indication of the policy.

7. The apparatus of claim 1, wherein the one or more parameters of the policy are to comprise one or more of: (i) parameters for the processor, (ii) parameters for a memory, (iii) parameters for an accelerator device, and (iv) parameters for a storage device.

8. A method, comprising:
receiving, by a controller from a core network, a request for an end-to-end managed connection, the end-to-end managed connection for an application executing on a server and an application executing on a client device, wherein the client device is coupled to the controller via a radio access network (RAN);
determining, by the controller, a policy for the end-to-end managed connection; and
applying, by the controller, one or more parameters of the policy to the end-to-end managed connection.

9. The method of claim 8, further comprising:
determining, by the controller, a network flow associated with the end-to-end managed connection, wherein the one or more parameters of the policy are to be applied to the network flow.

10. The method of claim 9, further comprising:
modifying, by the controller, the policy based on a machine learning algorithm applied to a plurality of attributes of the network flow and telemetry data for a plurality of compute nodes hosting the end-to-end managed connection; and
applying, by the controller, the modified policy to the network flow.

11. The method of claim 9, further comprising:
receiving, by the controller from the application executing on the client device and via the RAN, a packet;
parsing, by the controller, the packet to determine the packet is associated with the network flow; and
applying, by the controller, the policy to the packet based on the determination that the packet is associated with the network flow.

12. The method of claim 8, further comprising:
receiving, by the controller, a request to terminate the end-to-end managed connection;
terminating, by the controller, the end-to-end managed connection; and
releasing, by the controller, one or more computing resources based on the termination of the end-to-end managed connection.

13. The method of claim 8, further comprising:
transmitting, by the controller to the core network, an indication of the policy.

14. The method of claim 8, wherein the one or more parameters of the policy are to comprise one or more of: (i) parameters for a processor, (ii) parameters for a memory, (iii) parameters for an accelerator device, and (iv) parameters for a storage device.

15. A non-transitory computer-readable storage medium, the computer-readable storage medium including instructions that when executed by a processor of a controller, cause the processor to:
receive, from a core network, a request for an end-to-end managed connection, the end-to-end managed connection for an application executing on a server and an application executing on a client device, wherein the client device is coupled to the controller via a radio access network (RAN);
determine a policy for the end-to-end managed connection; and
apply one or more parameters of the policy to the end-to-end managed connection.

16. The computer-readable storage medium of claim 15, wherein the instructions further cause the processor to:
determine a network flow associated with the end-to-end managed connection, wherein the one or more parameters of the policy are to be applied to the network flow.

17. The computer-readable storage medium of claim 16, wherein the instructions further cause the processor to:
modify the policy based on a machine learning algorithm applied to a plurality of attributes of the network flow and telemetry data for a plurality of compute nodes hosting the end-to-end managed connection; and
apply the modified policy to the network flow.

18. The computer-readable storage medium of claim 16, wherein the instructions further cause the processor to:
receive from the application executing on the client device and via the RAN, a packet;
parse the packet to determine the packet is associated with the network flow; and
apply, by the controller, the policy to the packet based on the determination that the packet is associated with the network flow.

19. The computer-readable storage medium of claim 15, wherein the instructions further cause the processor to:
receive a request to terminate the end-to-end managed connection;
terminate the end-to-end managed connection; and
release one or more computing resources based on the termination of the end-to-end managed connection.

20. The computer-readable storage medium of claim 15, wherein the instructions further cause the processor to:
transmit, to the core network, an indication of the policy.
